(19) United States
(12) Patent Application Publication
(10) Pub. No.: US 2009/0046203 A1
(43) Pub. Date: Feb. 19, 2009

(54) VIDEO DATA PROCESSING APPARATUS AND METHOD FOR GENERATING A DIGITAL VIDEO DATA STREAM

(76) Inventor: Wilfried Platzer, Freiburg (DE)

Correspondence Address: Patrick J. O'Shea;O'Shea Getz P.C., Suite 912, 1500 Main Street, Springfield, MA, 01115, US

(21) Appl. No.: 12/193,458

(22) Filed: Aug. 18, 2008

(30) Foreign Application Priority Data
Aug. 16, 2007 (DE) 10 2007 038 861.8

(51) Int. Cl. H04N 7/00; H04N 5/445; H04N 7/173

(52) U.S. Cl. 348/461; 725/38; 725/131; 348/E07.001

(57) ABSTRACT

The invention relates to a video data processing apparatus and a method for generating a digital video data stream. The video data processing apparatus is equipped with an input for the input of at least digital video data (vi), a processing unit for the processing of at least the input video data (vi), an output for the output of the processed video data (vi) and a control interface for interrupt and/or status data (di, ds), the processing unit and/or a data insertion unit insert the interrupt and/or status data (di, ds) into the input digital video data (vi), and the output (O) generating, as digital output data stream (vo), the input video data (vi) having the interrupt and/or status data (di, ds) placed or incorporated thereinto.

### PRIORITY INFORMATION

This patent application claims priority from German patent application 10 2007 038 861.8 filed Aug. 16, 2007, which is hereby incorporated by reference.

### BACKGROUND OF THE INVENTION

The invention relates to video data processing, and in particular to generating a video data stream, where interrupt and/or status data are transmitted between two apparatuses in addition to video data.

As is illustrated in exemplary representative fashion in FIG. 5 for a disposition according to the prior art, video data vi input to a first video data processing apparatus TX′ are generated as a digital output data stream vo at an output of video data processing apparatus TX′. These video data in output data stream vo are supplied to a receiver RX′, which further processes the received video data and, as appropriate, outputs them as receiver output data ro. In addition to video data vi input at an input of video data processing apparatus TX′, interrupt and/or status data di, ds are additionally applied to another input of video data processing apparatus TX′. Alternatively, such interrupt and/or status data di, ds can also be generated in a processing unit of video data processing apparatus TX′. In parallel with video data vi processed in video data processing apparatus TX′, interrupt and/or status data di, ds are also passed on, via a parallel link, to receiver RX′ as second video data processing apparatus. In dependence on interrupt and/or status data di, ds additionally received via a parallel link, the receiver processes the video data received from video data processing apparatus TX′ via output data stream vo of the video data processing apparatus.

A known alternative to the use of separate input/output lines and interrupt lines for transmission between two such video data processing apparatuses is the retrieval of such items of information via a serial control bus such as for example according to I²C, SPI or Microwire buses. While the first-named approach has the disadvantage of limited resources and necessitates complicated circuit-board layouts, disadvantages of the second approach include limited bandwidth on the control bus. In many cases such buses are connected behind other buses, such as for example in the case of USB, PCI or Firewire, which further magnifies the problem.

There is a need for a technique for processing video data that makes possible a simple design approach with simultaneously efficient transmission of video data and additional data such as the interrupt data or items of status information.

### SUMMARY OF THE INVENTION

According to an aspect of the invention, a video data processing apparatus includes a processing unit for processing input video data to provide processed digital video data, and a control interface within the processing unit for reading requests from a video receiver. The processing unit and/or a data insertion unit are place or incorporate interrupt and/or status data into the video data, and the output generates the processed digital video data having the interrupt and/or status data placed or incorporated thereinto in correspondence with a read request that has occurred.

The processing unit and/or the data insertion unit preferably place or incorporate the interrupt and/or status data as self-contained data between the digital video data proper.

The processing unit and/or the data insertion unit may place or incorporate the interrupt and/or status data as self-contained data into data stream regions not used for the digital video data proper. The processing unit and/or the data insertion unit may place or incorporate the interrupt and/or status data into a video blanking region. The video blanking region can be in particular a blanking region or a blanking interval.

The processing unit and/or the data insertion unit may place or incorporate the interrupt and/or status data in a marked region of the output data stream. The processing unit and/or the data insertion unit may place or announce the interrupt and/or status data per se and/or their position in a header segment of the output data stream. The processing unit and/or the data insertion unit may place or incorporate the interrupt and/or status data in a fixedly specified region of the output data stream.

The interrupt and/or status data are preferably placed or incorporated as self-contained data between the digital video data proper. The interrupt and/or status data are preferably placed or incorporated as self-contained data into data stream regions unutilized for the digital video data proper. The interrupt and/or status data can be placed or incorporated into a video blanking region. The interrupt and/or status data are preferably placed or incorporated in a marked region of the output data stream. The interrupt and/or status data can also be placed or announced in a header segment of the output data stream. Alternatively, the interrupt and/or status data can also be placed or incorporated in a fixedly specified region of the output data stream.

Furthermore, what is independently preferred as further component of a video data processing system is a video data processing apparatus for receiving an output data stream of such an apparatus or of such a method, having an input for the input of video data having the interrupt and/or status data placed or incorporated thereinto, having a processing unit for separating the video data from the interrupt and/or status data placed or incorporated thereinto and having an output for the output of the processed video data or of the processing unit or of a further processing unit for the further processing of the video data.

Audio data may be associated with the video data or the video data may comprise audio data in addition to image data. The data in question can be fixedly associated data blocks but also signals or data sequences to be processed separately from one another.

Because the digital video bus used in every case is used as an output line for transmitting the output data stream having the video data or also, as applicable, audio data linked therewith for additionally further informational data such as status and interrupt messages, one or a plurality of separate lines for transmitting such status and interrupt data are omitted. Alternatively, such data can be employed as additional video data lines in order for example to enhance the total throughput of video data. It is especially preferred that additional data in the form of status and interrupt data are inserted into regions of the data stream in which no active video data or audio data are being transmitted, that is, in particular, in so-called video blanking regions. Also advantageous are embodiments in which a header segment, a so-called header, indicates and/or signals the presence of such items of information. In addition or alternatively, provision may also be made for inserting such items of information at defined positions within the data stream.

A receiver-side video data processing apparatus is desirably generated in corresponding fashion as a receiver for receiving such an output data stream, which apparatus can separate, out of the received output data stream, the received video data and, as applicable, audio data from interrupt and/or status data placed or incorporated thereinto.

Possible fields of application are in particular the placement of a macrovision status, a video decoder status, an audio decoder status, RDS data, an interrupt request and/or generic messages into the data stream of video data and/or audio data.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 is a block diagram illustration of a video data processing apparatus for placing status and interrupt data into a video data stream;

FIG. 2 is a block diagram illustration of a video data processing apparatus for placing status and interrupt data into a video data stream;

FIG. 3 illustrates a second embodiment of a video data processing apparatus;

FIG. 4 illustrates a receiver-side video data processing apparatus for receiving an output data stream having status and interrupt data embedded in an output data stream containing video data and, as applicable, audio data; and

FIG. 5 depicts schematically a disposition of two video data processing apparatuses according to the prior art.

### DETAILED DESCRIPTION OF THE INVENTION

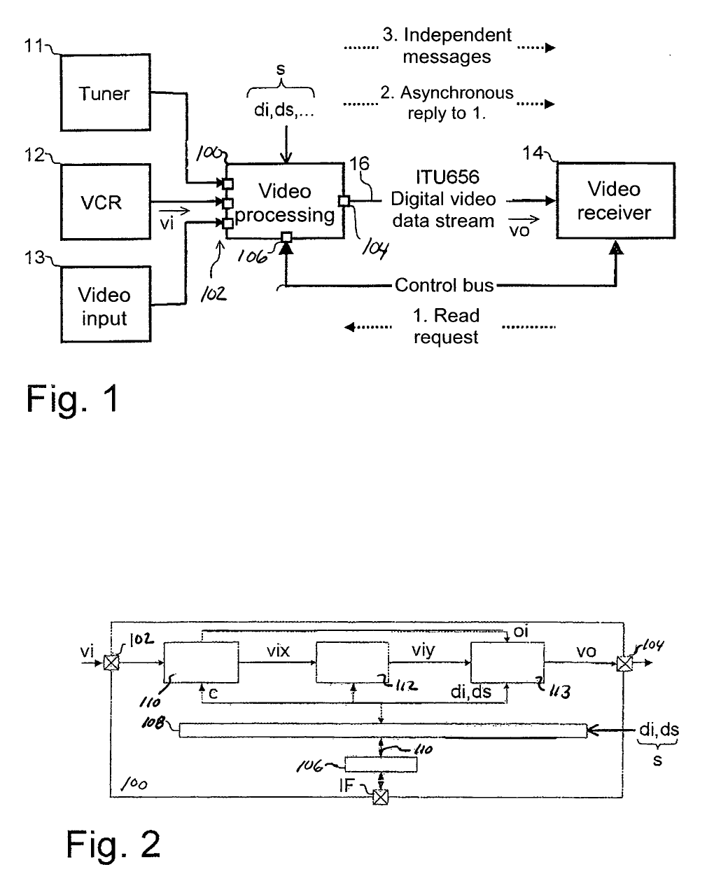

FIG. 1 illustrates a video data processing apparatus 100 to which various data sources 11-13 are connected on the input side. The data sources 11-13 may include a tuner 11, a video recorder 12 and a video input source 13. A receiver 14 is connected to the video data processing apparatus 100 on the output side, via a data line 16 for a data stream. The receiver 14 conditions and reproduces video and/or audio data. The video data processing apparatus 100 and the receiver 14 are linked via a control line 15, in particular a control bus for transmitting control instructions or read requests therebetween. The receiver 14 is preferably a video receiver.

The video data processing apparatus 100 includes an input 102 for the input of video data, in particular digital video data vi; an integrated processing unit proper 102 for processing at least the input video data vi; an output 104 for the output of the processed video data onto the data line 16; and a control interface 106 for read requests of the video receiver 14. The processing unit 100 and/or a data insertion unit place or incorporate interrupt data di and/or status data ds (hereinafter identified by reference character s) into the input video data vi. As processed video data or as digital output data stream vo, the output interface 104 generates the input video data vi having interrupt and/or status data s placed or incorporated thereinto. Here the requisite interrupt and/or status data are placed in compliance with the applicable video standards.

The output interface 104 may be implemented as a digital unidirectional output that transports video signals, in particular, output data stream vo. Output data stream vo proper, for example, video data stream in compliance with ITU-R BT.656-4 (February 1998), comprises useful data, such as for example, useful video data, and blanking, that is, times in which no useful data occur. Other data such as for example Teletext or audio data complying with, for example, Rec. ITU-R BT.1364-1 (August 2005) may be transmitted in the corresponding blanking intervals.

The receiver 14 controls the video data processing apparatus 100 via the control line 15 in the form of the control bus.

The control bus 15 is commonly relatively very slow and, in the case of read operations, for example “1. Read request,” greatly retards present-day processors having processing speeds greater than the transmission speeds of the control bus. While bus speeds are currently in the 100 kHz range, the processing speeds of current processors are in the megahertz and gigahertz range, so that replies via the same slow control bus 15 come back too slowly.

The problem is remedied through the use of an asynchronous model, and the control bus 15 may be used between the video data processing apparatus 100 and the receiver 14. The processors of the video data processing apparatus 100 and the receiver 14 may operate at processing speeds greater than the transmission speeds of the control bus 15. In particular, there is no problem if the ratio of processing speeds to transmission speeds is equal to a thousand or more.

Given an appropriately implemented asynchronous model, the read—i.e., “1. Read request” in FIG. 1—is performed as a write. In particular when so-called posted writes are employed as write procedures, this can be effected without major retarding impacts for the processor or processors.

A reply—i.e., a “2. Asynchronous reply to 1.” Illustrated in FIG. 1—is then sent via the link of the video data stream, that is, of output data stream vo. It is feasible that a reply is sent via the output data stream vo for every read request received via the control interface 106.

Optionally, by a repetitive sending procedure, the reply can be sent to the receiver 14 again and again via the output data stream vo until a signal or data signalizing and bringing about a termination of repetitive sending are received via the control line 15 and the control interface 106. This saves repetitive sending or read requesting via the slow control line 15.

Additional links to the receiver 14, for example interrupt lines known per se, can also advantageously be omitted if appropriate instructions are placed into the output data stream vo as “3. Independent messages” in FIG. 1, for example the interrupts that would otherwise be transmitted via their own interrupt lines.

As can be seen from FIG. 2, the video data processing apparatus 100 includes an input interface 102 for the input of the video data vi (in particular digital video data) and, as applicable, also digital audio data of at least one of the data sources 11-13 (FIG. 1), as well as the output interface 104 for the output of the processed video data and, as applicable, audio data in digital output data stream vo. One or a plurality of components for processing the input video data vi and, as applicable, also audio data are connected between the input 102 and the output 104.

Furthermore, the video data processing apparatus 100 displays the control interface for the read request of the video receiver 14. In the embodiment illustrated, the control interface 106 communicates with a control unit 108 via a bidirectional link 110.

The control unit 108 is also linked via (in particular bidirectional) lines or buses to further processing unit or units 110. The control unit 108 controls corresponding processing units 110 in such fashion that these analyze and/or process the received video data vi and, as applicable, audio data. To this end, along with the read request, the control unit 108 can also send and/or receive interrupt and/or status data di, ds to a data insertion unit 113, also informational and/or control data c.

According to the first exemplary embodiment, digital video data vi are preprocessed and, as applicable, also examined for data structures in a first processing unit 110 receiving digital video data vi from the input. Optionally, a search can also be made in received video data vi for data stream regions in which there are redundant video data or no video data, in order that interrupt and/or status data di, ds can be placed into such regions of the data stream instead of the original data.

As applicable, the preprocessed video data vix are output by the processing unit 110 to a data stream encoding unit 112, which is likewise operated under the control of the control unit C. Data stream encoding unit 112 generates the input-side video data vix, preprocessed as applicable, and, as applicable, audio data as a formatted data stream viy, this formatted data stream viy being applied to the input side of the data insertion unit 113. Under the control of the control unit 108, the data insertion unit 113 inserts interrupt data di and/or status data ds into appropriate data stream regions. Optionally, further data, for example audio data oi or other informational data, can also be applied to a further input of the data insertion unit 113 directly from the first processing unit 110, via an optional further data path, and employed for control or insertion.

The data insertion unit 113 modifies received formatted data stream viy in such fashion that output data stream vo output at the output is generated with video data, audio data as applicable, and additionally the inserted interrupt and/or status data di, ds.

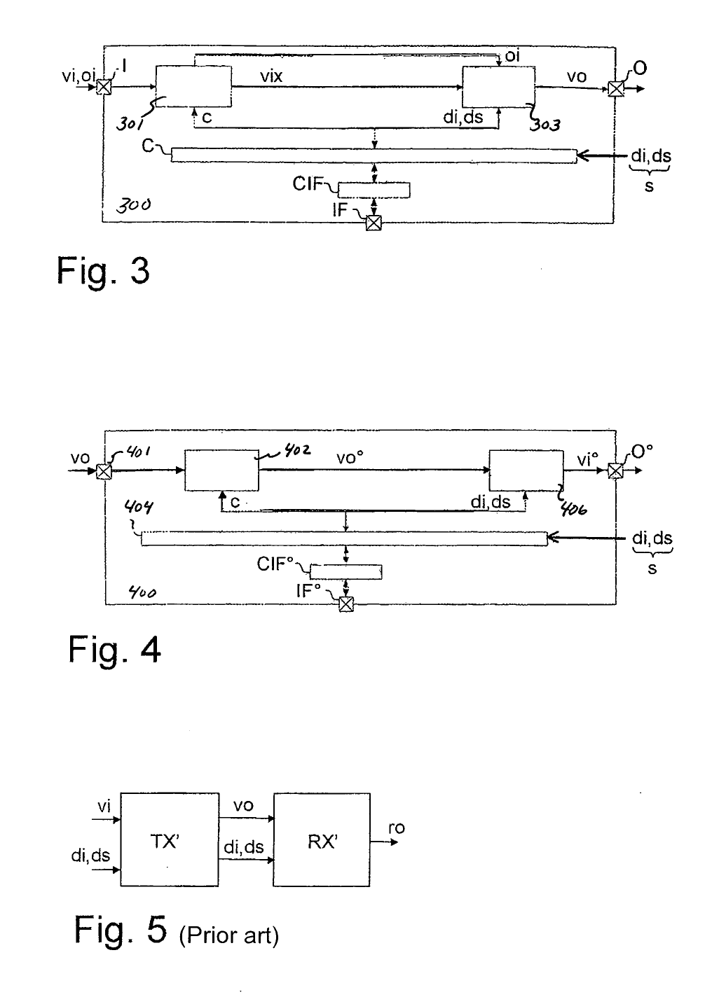

FIG. 3 illustrates a modified video data processing apparatus 300, which differs from the first embodiment in that data stream encoding unit 112 is omitted and digital video data vi and audio data oi from an input-side processing unit 301, received on the input side, are directly applied to an output-side data insertion unit 303 as modified or processed video data vix and, as applicable, audio data oi. The remaining components and functions correspond to those of the first exemplary embodiment according to FIG. 2.

Optionally, a further combination can occur in such fashion that a single processing component modifies receiver-side video data vi and/or audio data oi directly to output data stream vo into which this one processing unit is itself already placing the corresponding additional data, in particular interrupt and/or status data di, ds.

FIG. 4 illustrates an yet another embodiment of a video data processing apparatus 400 for receiving such an output data stream vo, it being possible for such a video data processing apparatus, fashioned for example as a receiver, to display components substantially comparable to the apparatuses according to FIGS. 2 and 3. At an input-side input 401, however, data of output data stream vo are received and applied to a processing unit 402. Under the control of a control unit 404, the processing unit 402 analyzes the received data of output data stream vo for contained video data, audio data and additional data, in particular additional interrupt and/or status data di, ds. Data vo°, preprocessed as applicable, are then supplied to a data separation unit 406, which effects a separation into video data vi° and, as applicable, audio data on the one hand and, on the other hand, interrupt and/or status data di, ds. Optionally, further processing of the data for reproduction on a screen and/or for output to downstream processing apparatuses can be provided via an output O°.

Finally, further modifications of the several video data processing apparatuses TX, TX°, RX are possible, in particular modifications through integration of various functions in a single design element or a further splitting into still more components.

In terms of method, interrupt and/or status data are thus embedded as additional data in a sequence of digital video data and, as applicable, audio data and jointly generated in a single output data stream for a further video data processing apparatus.

Although the present invention has been illustrated and described with respect to several preferred embodiments thereof, various changes, omissions and additions to the form and detail thereof, may be made therein, without departing from the spirit and scope of the invention.

What is claimed is:

1. A video data processing apparatus that provides processed digital video data to a video receiver, comprising:
a processing unit that receives and processes input video data to provide the processed digital video data;
a control interface in the processing unit for reading requests from the video receiver; where
the processing unit places or incorporates interrupt and/or status data (s) into the processed digital video data.

2. The apparatus of claim 1, wherein the processing unit and/or a data insertion unit are so fashioned as to place or incorporate the interrupt and/or status data (s) as self-contained data between the digital video data (vi) proper.

3. The apparatus of claim 1, wherein the processing unit and/or a data insertion unit are so fashioned as to place or incorporate the interrupt and/or status data (s) as self-contained data into data stream regions unutilized for the digital video data (vi) proper.

4. The apparatus of claim 3, wherein the processing unit and/or the data insertion unit are so fashioned as to place or incorporate the interrupt and/or status data (s) into a video blanking region.

5. The apparatus of claim 2, wherein the processing unit and/or the data insertion unit are so fashioned as to place or incorporate the interrupt and/or status data (s) in a marked region of the output data stream (vo).

6. The apparatus of claim 2, wherein the processing unit and/or the data insertion unit are so fashioned as to place or announce the interrupt and/or status data (s) per se and/or their position in a header segment of the output data stream (vo).

7. The apparatus of claim 3, wherein the processing unit and/or the data insertion unit are so fashioned as to place or incorporate the interrupt and/or status data (di, ds) in a fixedly specified region of the output data stream (vo).

8. A method for generating a digital video data stream as an output data stream (vo) wherein interrupt and/or status data (s) are generated in addition to input video data (vi) at an output (O), the method comprising:
inserting interrupt and/or status data (s) into the input video data (vi) in response to a read request of a video receiver, and providing processed digital video data indicative thereof, and
outputting the processed digital video data containing the input video data (vi) having the interrupt and/or status data (di, ds) as output data stream (vo).

9. The method of claim 8, wherein the interrupt and/or status data (di, ds) are placed or incorporated as self-contained data between the digital video data (vi) proper.

10. The method of claim 9, wherein the interrupt and/or status data (di, ds) are placed or incorporated as self-contained data into data stream regions unutilized for the digital video data (vi) proper.

11. The method of claim 10, wherein the interrupt and/or status data (di, ds) are placed or incorporated into a video blanking region.

12. The method of claim 11, wherein the interrupt and/or status data (di, ds) are placed or incorporated in a marked region of the output data stream (vo).

13. The method of claim 8, wherein the interrupt and/or status data (di, ds) are placed or announced in a header segment of the output data stream (vo).

14. The method of claim 8, wherein the interrupt and/or status data (di, ds) are placed or incorporated in a fixedly specified region of the output data stream (vo).

15. A video data receiver (RX) for receiving an output data stream (vo), comprising:
an input (I°) for the input of video data (vi°) having the interrupt and/or status data (di, ds) placed or incorporated thereinto;
a processing unit (1°) for separating the video data (vi°) from the interrupt and/or status data (di, ds) placed or incorporated thereinto; and
an output (O°) for the output of the processed video data (vi°) or the processing unit (1°) or a further processing unit (2°) for the further processing of the video data (vi°).
